(19) United States
(12) Patent Application Publication
(10) Pub. No.: US 2021/0378224 A1
(43) Pub. Date: Dec. 9, 2021

(54) FISHING AID

(71) Applicant: Joanne Sigman, (US)

(72) Inventor: Wesley Sigman, South Haven, MN (US)

(21) Appl. No.: 17/340,646

(22) Filed: Jun. 7, 2021

Related U.S. Application Data
(60) Provisional application No. 63/035,699, filed on Jun. 6, 2020.

(51) Int. Cl. A01K 97/10; A01K 97/01

(52) U.S. Cl. CPC A01K 97/10; A01K 97/01

(57) ABSTRACT

Various aspects of the present disclosure are directed toward a fishing rod holder that includes a mounting portion configured to mount to a portion of a support structure and extend the fishing rod holder outwardly from the support structure. The fishing rod holder may also include a first rod holding portion including a first linear section extending away from the mounting portion and a curved portion at an end of the first linear section configured to at least partially surround a portion of a fishing rod. The fishing rod holder also may include a line release portion configured to releasably mount to a bottom surface of the first rod holding portion, and apply tension to the fishing line.

### CROSS-REFERENCE TO RELATED APPLICATION

This application claims priority to U.S. Provisional Patent Application No. 63/035,699 filed Jun. 6, 2020, which is herein incorporated by reference in its entirety.

### FIELD

The present disclosure relates generally to apparatuses, systems, and methods for assisting in fishing. More specifically, the disclosure relates to apparatuses, systems, and methods that may be used during the winter for ice fishing.

### BACKGROUND

Fishing rods, when used in winter for example, may be used to fish through a hole drilled through ice in a fish house. A bobber or floating indicator may be used when waiting for a fish to keep bait or lure suspended at a chosen depth. Multiple fishing rods or setups may be used, and a person monitoring the fishing rods would watch each bobber and risk missing a fish taking bait or an offering while the person is not looking or actively monitoring one of the rods or setups.

### SUMMARY

According to one example (“Example 1”), a fishing rod holder includes a mounting portion configured to mount to a portion of a support structure and extend the fishing rod holder outwardly from the support structure; a first rod holding portion including a first linear section extending away from the mounting portion and a curved portion at an end of the first linear section configured to at least partially surround a portion of a fishing rod; a first screw arranged through the mounting portion configured to allow for the fishing rod to pivot in response to tension applied to fishing line; and a line release portion includes a pathway for the fishing line, the line release portion being configured to: releasably mount to a bottom surface of the first rod holding portion, and apply tension to the fishing line.

According to another example (“Example 2”), further to the fishing rod holder of Example 1, the first screw is arranged at a center point of the mount portion.

According to another example (“Example 3”), further to the fishing rod holder of Example 1, the line release portion includes a screw configured to vary an amount of tension on the fishing line.

According to another example (“Example 4”), further to the fishing rod holder of Example 3, the screw is configured to alter a dimension of the pathway to vary the amount of tension on the fishing line.

According to another example (“Example 5”), further to the fishing rod holder of Example 4, the screw engages a bearing arranged within the pathway that is configured to vary the amount of tension on the fishing line.

According to another example (“Example 6”), further to the fishing rod holder of Example 1, further including a tensioner configured to releasably mount the line release portion to the first rod holding portion.

According to another example (“Example 7”), further to the fishing rod holder of Example 6, the tensioner is a zip-tie configured to releasably mount the line release portion to the first rod holding portion.

According to another example (“Example 8”), further to the fishing rod holder of Example 1, further including a second rod holding portion configured to at least partially surround a portion of a fishing rod.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is an example fishing rod holder in accordance with an embodiment;

FIG. 2 is a view of a line release portion, used with the fishing rod holder shown in FIG. 1, in accordance with an embodiment;

FIG. 3 is close up view of the example fishing rod holder, shown in FIG. 1, in accordance with an embodiment;

FIG. 4 is an example fishing rod holder and fishing rod, in accordance with an embodiment.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

### DESCRIPTION OF VARIOUS EMBODIMENTS

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

Various aspects of the present disclosure are directed toward a fishing aid and methods of using a fishing aid. The fishing aid, as described in detail below, may be used in the winter, for example, when fishing through a hole drilled through the ice in a fish house. In certain instances, the fishing aid may be attached to a wall, wall stud or similar structure in the fishing house. The fishing aid may hold a fishing rod with a lure placed through the hole in the ice attached to a fishing line. The fishing aid may obliviate the need for a bobber or visual indicator (although one may be used). When a fish has taken your bait or lure, the fish may swim off and attempt to eat your offering. If the fish has your offering in its mouth and feels any kind of resistance from the bobber or sinker (or something else), it can raise alarm the fish and it will spit out your offering and throw the hook. The fishing rod holder, as discussed in detail below, allows the fish to swim off without the resistance (e.g., of a sinker, bobber, tangled run line or fishing rod) to alarm the fish. The result is more hook ups and more fish caught.

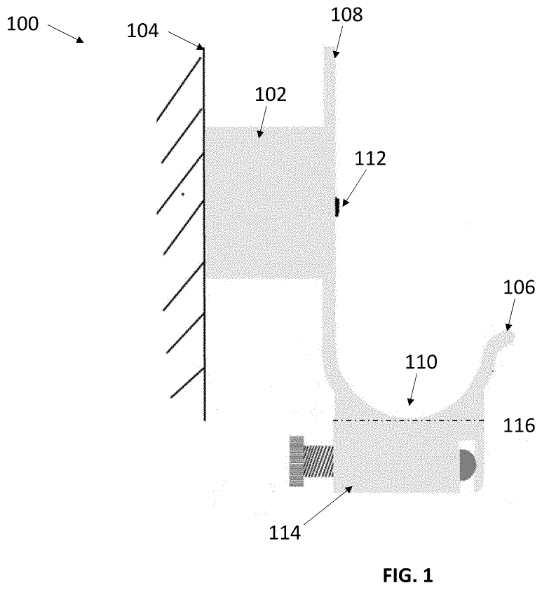

FIG. 1 is an example fishing rod holder 100 in accordance with an embodiment. The fishing rod holder 100 may include a mounting portion 102 configured to mount to a portion of a support structure 104 and extend the fishing rod holder outwardly from the support structure 104.

The fishing rod holder 100 may also include a first rod holding portion 106 that includes a first linear section 108 extending away from the mounting portion 102 and a curved portion 110 at an end of the first linear section 108. The curved portion 110 may be configured to at least partially surround a portion of a fishing rod. In certain instances, the fishing rod holder 100 may be mounted or attached to the support structure 104 by way of the mounting portion 102 using an adhesive, screw, or nail. In certain instances, a first screw 112 may be arranged through the mounting portion 102. The first screw 112 may be configured to allow for the fishing rod to pivot in response to tension applied to fishing line. In addition, the first screw 112 may be arranged at a center point of the mount portion 102.

The fishing rod holder 100 may also include a line release portion 114 having a pathway 116 for the fishing line. in certain instances, the line release portion 114 may be configured to: releasably mount to a bottom surface of the first rod holding portion 106, and apply tension to the fishing line.

As noted above, the mounting portion 102 may be configured to support, hold the fishing rod and allow the fishing rod to pivot. The mounting portion 102 may be mounted to the support structure 104 such that it is out of the way and in a convenient and safe place.

The first rod holding portion 106 may be configured to a cradle or hold the fishing rod. In addition, the line release portion 114 may hold line from the fishing rod in the pathway 116 may hold the line in place and release the line in response to a fish taking bait and applying tension to the fishing line. The line release portion 114 may allow the fish to take the bait and line without pressure from a bobber or other indicator, which, in turn, will not alarm the fish. The line release portion 114 may allow for the fishing reel bail to be open and not have fishing line pile or tangle on the floor.

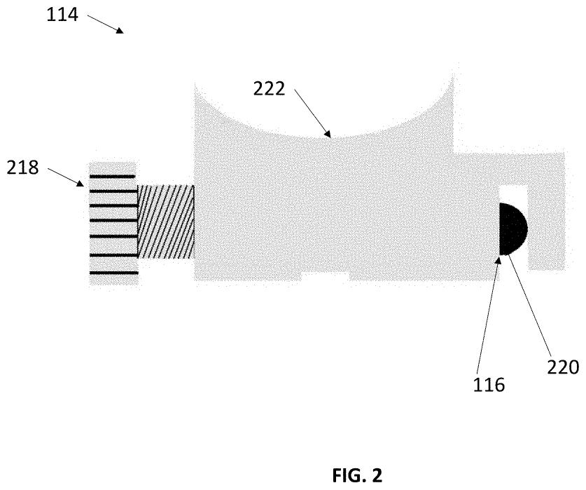

FIG. 2 is a view of a line release portion 114, that may be used with the fishing rod holder 100 shown in FIG. 1, in accordance with an embodiment. In certain instances, the line release portion 114 may be reasonably coupled or attached to the a portion of the fishing rod holder 100. This may enable fishing line to be routed or arranged through a space or pathway without having to thread the line through a space between the line release portion 114 and the fishing rod holder 100. The line may be arranged adjacent the first rod holding portion 106, for example, and then the line release portion 114 may be attached or coupled to the first rod holding portion 106.

In certain instances, the line release portion 114 may include a screw 218 that may be configured to vary an amount of tension on the fishing line. A person may turn the screw to adjust an amount of tension that is applied to the fishing line. The screw 218 may engage a bearing 220 that allows for altering of a dimension of the pathway 116 for the fishing line. The screw 218 may be configured to vary the amount of line pull pressure needed to release the line. For example, when fishing for larger fish, the pressure may be increased by turning the screw 218. One or more springs may be arranged along the screw 218 between the bearing 220 to vary the pressure. In certain instances, a plug may be arranged between springs in along the screw 218 to keep the two springs from intermeshing together. The bearing 220 may create a contact point that holds the fishing line. in addition and as noted above, the screw 218 may be configured to alter a dimension of the pathway 116 to vary the amount of tension on the fishing line and the screw 218 may engage the bearing 220 to forming an end of the pathway 116 that is configured to vary the amount of tension on the fishing line. A portion of the line release portion 114 may form another end of the pathway 116.

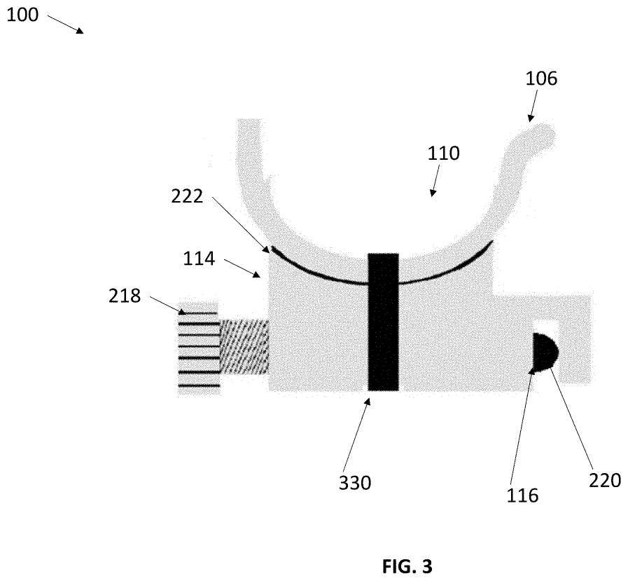

In certain instances, an upper surface 222 of the line release portion 114 may include a complementary shape to a lower surface of a portion of the fishing rod holder 100 such as the first rod holding portion 106. As shown in FIG. 3, a tensioner 330 may be used to couple the line release portion 114 to the fishing rod holder 100 (e.g., the first rod holding portion 106).

In certain instances, the tensioner 330 may be a zip-tie, rubber band, thread, or other structure that may secure the line release portion 114 to the first rod holding portion 106.

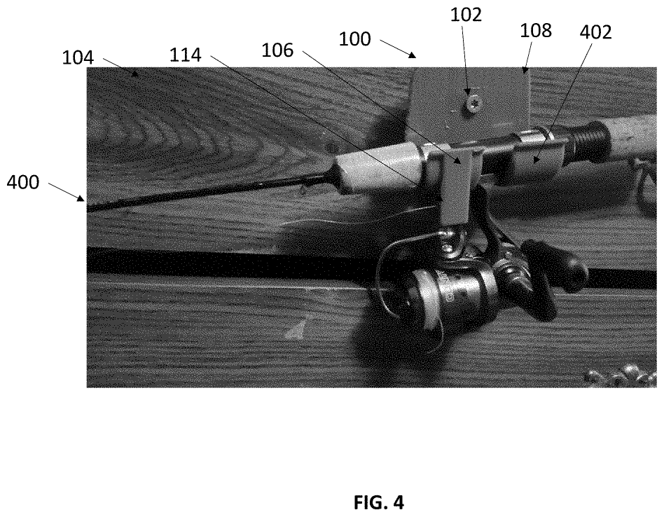

FIG. 4 is an example fishing rod holder 100 and fishing rod 400, in accordance with an embodiment. As described in detail above, the fishing rod holder 100 may include a mounting portion (not shown) configured to mount to a portion of a support structure 104 and extend the fishing rod holder outwardly from the support structure 104.

The fishing rod holder 100 may also include a first rod holding portion 106 that may be configured to at least partially surround a portion of the fishing rod 400. In certain instances, the fishing rod holder 100 may be mounted or attached to the support structure 104 by way of the mounting portion 102 using an adhesive, screw, or nail. In certain instances, a first screw 112 may be arranged through the mounting portion 102. The first screw 112 may be configured to allow for the fishing rod 400 to pivot in response to tension applied to fishing line. In addition, the first screw 112 may be arranged at a center point of the mount portion 102.

The fishing rod holder 100 may also include a line release portion 114 having a pathway 116 for the fishing line. in certain instances, the line release portion 114 may be configured to: releasably mount to a bottom surface of the first rod holding portion 106, and apply tension to the fishing line.

As noted above, the mounting portion 102 may be configured to support, hold the fishing rod 400 and allow the fishing rod 400 to pivot. The mounting portion 102 may be mounted to the support structure 104 such that it is out of the way and in a convenient and safe place.

The first rod holding portion 106 may be configured to a cradle or hold the fishing rod 400. The fishing rod holder 100 may also include a second rod holding portion 402 configured to at least partially surround a portion of a fishing rod 400.

In addition, the line release portion 114 may hold line from the fishing rod in place and release the line in response to a fish taking bait and applying tension to the fishing line. The line release portion 114 may allow the fish to take the bait and line without pressure from a bobber or other indicator, which, in turn, will not alarm the fish. The line release portion 114 may allow for the fishing reel bail to be open and not have fishing line pile or tangle on the floor.

In certain instances, the fishing rod holder 100 may allow a person to see a fish approaching or starting to attack a lure or bait by way of the tip of the fishing rod 400 moving. The fishing rod holder 100 may allow for even a slight amount of movement or tension on the bait or lure to be visually seen. When a fish takes the offering, the fishing rod holder 100 is configured to allow for the fishing rod 400 to abruptly move, and the fishing rod holder 100 allows the fishing rod 400 to pivot.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A fishing rod holder comprising:
a mounting portion configured to mount to a portion of a support structure and extend the fishing rod holder outwardly from the support structure;
a first rod holding portion including a first linear section extending away from the mounting portion and a curved portion at an end of the first linear section configured to at least partially surround a portion of a fishing rod;
a first screw arranged through the mounting portion configured to allow for the fishing rod to pivot in response to tension applied to fishing line; and
a line release portion includes a pathway for the fishing line, the line release portion being configured to: releasably mount to a bottom surface of the first rod holding portion, and apply tension to the fishing line.

2. The fishing rod holder of claim 1, wherein the first screw is arranged at a center point of the mount portion.

3. The fishing rod holder of claim 1, wherein the line release portion includes a screw configured to vary an amount of tension on the fishing line.

4. The fishing rod holder of claim 3, wherein the screw is configured to alter a dimension of the pathway to vary the amount of tension on the fishing line.

5. The fishing rod holder of claim 4, wherein the screw engages a bearing arranged within the pathway that is configured to vary the amount of tension on the fishing line.

6. The fishing rod holder of claim 1, further including a tensioner configured to releasably mount the line release portion to the first rod holding portion.

7. The fishing rod holder of claim 6, wherein the tensioner is a zip-tie configured to releasably mount the line release portion to the first rod holding portion.

8. The fishing rod holder of claim 1, further including a second rod holding portion configured to at least partially surround a portion of a fishing rod.
